(19) United States
(12) Patent Application Publication
(10) Pub. No.: US 2025/0261270 A1
(43) Pub. Date: Aug. 14, 2025

(54) MULTICASTING IN A COMMUNICATION SYSTEM

(71) Applicant: Nokia Technologies Oy, Espoo (FI)

(72) Inventors: Horst Thomas BELLING, Munich (DE); Philippe GODIN, Massy (FR); David NAVRÁTIL, Espoo (FI)

(21) Appl. No.: 18/852,195

(22) PCT Filed: Mar. 24, 2023
(86) PCT No.: PCT/IB2023/052956

§ 371 Date: Sep. 27, 2024

(30) Foreign Application Priority Data
Mar. 29, 2022 (GB) 2204470.5

(51) Int. Cl. H04W 76/27; H04W 76/40

(52) U.S. Cl. CPC H04W 76/27; H04W 76/40

(57) ABSTRACT

There is provided methods, apparatuses and computer program products for multicasting in a communication system. A method for multicasting in a communication system comprises deciding to use a transmission mode for inactive state reception for a multicast session in an area, providing information for at least one device in the area indicative of the use of the transmission mode for inactive state reception for the multicast session, and transmitting data in the multicast session using the transmission mode for inactive state reception.

### RELATED APPLICATIONS

This patent application claims the benefit of priority of United Kingdom Patent Application No. 2204470.5, filed Mar. 29, 2022, which is hereby incorporated by reference in its entirety.

### FIELD

The present disclosure relates to methods, apparatuses and computer program products for multicasting in a communication system.

### BACKGROUND

Data can be communicated between communication devices such as user or terminal devices, base stations/access points and/or other nodes. Communication may be provided, for example, by means of a communication network and one or more compatible communication devices. A communication device at a network side provides an access point to the system and is provided with an appropriate receiving and transmitting apparatus for enabling communications. Communications may comprise, for example, communication of data for carrying voice, video, electronic mail (email), text message, multimedia and/or content data communications and so on. Non-limiting examples of services provided comprise two-way or multi-way calls, data communication, multimedia services and access to a data network system, such as the Internet. It is also possible to multicast and/or broadcast to communication devices.

In a mobile or wireless communication system at least a part of data communication occurs over a wireless or radio link. Examples of wireless systems comprise public land mobile networks (PLMN), satellite-based communication systems and different wireless local networks, for example wireless local area networks (WLAN). The wider communication system can be accessed by means of an appropriate communication device or terminal. Such a device is often referred to as a user equipment (UE). A communication device is provided with an appropriate signal receiving and transmitting apparatus for enabling communications, for example for enabling access to a communication network or communications directly with other users. A communication device of a user may receive signalling by a node at a radio access network (RAN), for example a base station, and transmit and/or receive communications accordingly.

The communication system and associated devices typically operate in accordance with a given standard or specification which sets out the functionalities and tasks of the various entities associated with the system. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) and so-called fifth generation (5G) or New Radio (NR) system. 5G is being standardized by the 3rd Generation Partnership Project (3GPP). Different versions of the 3GPP specifications are called Releases (Rel).

Data can be broadcast or multicast to multiple of devices. Services provide the ability to deliver content to multiple users, and unlike in unicast services, data can be transmitted simultaneously from a single source to multiple destinations/devices. An example of these services is Multicast Broadcast Service (MBS) which provides point-to-multipoint communication.

### SUMMARY

In accordance with an aspect there is provided a method comprising deciding to use a transmission mode for inactive state reception for a multicast session in an area, providing information for at least one device in the area indicative of the use of the transmission mode for inactive state reception for the multicast session, and transmitting data in the multicast session using the transmission mode for inactive state reception.

In accordance with a more specific aspect the method may comprise receiving capability information indicative that the at least one device supports inactive state reception of multicast sessions.

The inactive state reception may comprise reception in at least one of a radio recourse control (RRC) inactive state or a radio recourse control (RRC) idle state.

A decision to use a multicast transmission mode for inactive state reception can at least in part be based on at least one of the number of devices in the area desiring to receive the multicast session, load in the area, capabilities of the devices in the area, radio resource control state of devices in the multicast session in the area or one or more notification areas including the area, capabilities of devices that have joined the multicast session in the area to receive multicast data while in radio resource control inactive state, preferences of devices that have joined the multicast session in the area to use the transmission mode for reception in inactive state or a transmission mode for reception in connected state, preferences received from a core network to use the transmission mode for reception in radio resource control inactive state or a transmission mode for reception in radio resource control connected state, and/or information that at least one device in a connected state is also capable of receiving data based on the multicast transmission mode for inactive state reception.

The method may comprise broadcasting information of the use of the transmission mode for inactive state reception.

The method may comprise transmitting at least one of information indicative that the transmission mode for inactive state reception is used for the multicast session, information indicative that a transmission mode for connected state reception is used for the multicast session, an identifier of the multicast session for which the transmission mode for inactive state reception is used, and/or information indicative that the transmission mode for inactive state reception is used for the multicast session in one or more neighbouring cells.

Information of use of a transmission mode for inactive state reception may comprises an indication whether the multicast session is inactive or active. Information of use of a transmission mode for inactive state reception may be provided only if the multicast session is active.

Providing information for at least one device indicative of use of the transmission mode for inactive state reception may comprise configuring the at least one device for monitoring of at least one point-to-multipoint control channel and transmitting an identifier associated with the multicast session.

Providing information for at least one device indicative of use of the transmission mode for inactive state reception may comprise configuring the at least one device for monitoring Multicast Control Channel/Multicast Traffic Channel (MCCH/MTCH) and transmitting the identifier for the MTCH for the multicast session on the MCCH.

The method may comprise transmitting information indicative of use of the transmission mode for connected state reception, said transmitting comprising configuring at least one device using dedicated RRC signaling for the reception of the multicast session.

The method may comprise instructing transition between a connected state reception mode and the inactive state reception mode. This may comprise sending a release message for transitioning a device from the connected state to the inactive state and identifying the multicast session for the inactive state reception.

In accordance with an aspect there is provided a method comprising receiving information indicative of use of a transmission mode for inactive state reception for a multicast session in an area and receiving data in the multicast session based on the information indicative of the transmission mode for inactive state reception.

The method may comprise sending of capability information indicative of support for the inactive state reception of multicast sessions.

The inactive state reception may comprise at least one of reception in a radio recourse control (RRC) inactive state and reception in a radio recourse control (RRC) idle state.

The method may comprise at least one of receiving an identifier of the multicast session for which the transmission mode for inactive state reception is used, receiving information whether the multicast session is inactive or active, receiving information indicative use of a transmission mode for connected state reception for a multicast session, and/or receiving information of the use of the transmission mode for inactive state reception only when the multicast session is active.

The method may comprise sending a request to join the multicast session and receiving a response comprising at least information regarding the success of the request to join and a multicast session identity.

The method may comprise receiving data of the multicast session based on the transmission mode for inactive state reception while being in a radio resource control connected state or radio resource control inactive state.

The method may comprise monitoring of at least one point-to-multipoint control channel and receiving an identifier associated with the multicast session on the monitored at least one point-to-multipoint control channel.

The method may comprise receiving information indicative that the transmission mode for inactive state reception is used for the multicast session in at least one or more neighbouring cells, and preparing to receive data for the multicast session based on the transmission mode for inactive state reception when selecting a cell of the one or more neighbouring cells or when being handed over to a cell of the one or more neighbouring cells.

The method may comprise transitioning between a connected state reception mode and the inactive state reception mode.

The method may comprise receiving a release message triggering transitioning from the connected state reception mode to the inactive state reception mode and identifying the multicast session for the inactive state reception.

The method may comprise sending a request for transitioning from the inactive state to the connected state in response to participating in a multicast session in the inactive state and at least one of receiving information indicative of use of the transmission mode for connected state reception for the multicast session or not receiving information indicative of use of the transmission mode for inactive state reception for the multicast session.

According to an aspect there is provided an apparatus for a radio access network node comprising at least one processor and at least one memory including a computer program code, the at least one memory and computer program code configured to, with the at least one processor, cause the apparatus at least to decide to use a transmission mode for inactive state reception for a multicast session in an area, provide information for at least one device in the area indicative of the use of the transmission mode for inactive state reception for the multicast session, and transmit data in the multicast session using the transmission mode for inactive state reception.

The apparatus may be configured to receive capability information indicative that the at least one device supports inactive state reception of multicast sessions.

The inactive state reception may comprise reception in at least one of a radio recourse control (RRC) inactive state or RRC radio recourse control (RRC) idle state. The apparatus may be configured to decide to use the multicast transmission mode for inactive state reception is at least in part based on at least one of the number of devices in the area desiring to receive the multicast session, load in the area, capabilities of the devices in the area, radio resource control state of devices in the multicast session in the area or one or more notification areas including the area, capabilities of devices that have joined the multicast session in the area to receive multicast data while in radio resource control inactive state, preferences of devices that have joined the multicast session in the area to use the transmission mode for reception in inactive state or a transmission mode for reception in connected state, preferences received from a core network to use the transmission mode for reception in radio resource control inactive state or a transmission mode for reception in radio resource control connected state, and/or information that at least one device in a connected state is also capable of receiving data based on the multicast transmission mode for inactive state reception.

The apparatus may be configured to cause broadcasting of information of the use of the transmission mode for inactive state reception.

The apparatus may be configured to cause transmitting at least one of information indicative that the transmission mode for inactive state reception is used for the multicast session, information indicative that a transmission mode for connected state reception is used for the multicast session, an identifier of the multicast session for which the transmission mode for inactive state reception is used, information indicative that the transmission mode for inactive state reception is used for the multicast session in one or more neighbouring cells, information whether the multicast session is inactive or active, and/or information for configuring the at least one device for monitoring of at least one point-to-multipoint control channel and transmitting an identifier associated with the multicast session.

The apparatus may be configured to transmit to at least one device information indicative use of a transmission mode for connected state reception for configuring the at least one device using dedicated RRC signaling for the reception of the multicast session.

The apparatus may be configured to at least one of provide the information of the use of the transmission mode for inactive state reception only if the multicast session is active, instruct transition between a connected state reception mode and the inactive state reception mode, and/or send a release message for transitioning a device from connected state reception to inactive state reception and identifying the multicast session for the inactive state reception.

In accordance with an aspect there is provided an apparatus for a device comprising at least one processor and at least one memory including a computer program code, the at least one memory and computer program code configured to, with the at least one processor, cause the apparatus at least to receive information indicative of use of a transmission mode for inactive state reception for a multicast session in an area, and receive data in the multicast session based on the information indicative of the transmission mode for inactive state reception.

The apparatus may be configured to cause sending of capability information indicative of support for the inactive state reception of multicast sessions. The apparatus may be configured to receive multicast data in at least one of a radio recourse control (RRC) inactive state or radio recourse control (RRC) idle state.

The apparatus may be configured at least one of receive an identifier of the multicast session for which the transmission mode for inactive state reception is used, receive the information whether the multicast session is inactive or active, receive information indicative of use of a transmission mode for connected state reception for a multicast session, receive information of the use of the transmission mode for inactive state reception only when the multicast session is active, and/or send a request to join the multicast session and receive a response comprising at least information regarding the success of the request to join and a multicast session identity.

The apparatus may be configured to receive data of the multicast session based on the transmission mode for inactive state reception while being in a radio resource control connected state or radio resource control inactive state.

The apparatus may be configured to monitor at least one point-to-multipoint control channel and receive an identifier associated with the multicast session on the monitored at least one point-to-multipoint control channel.

The apparatus may be configured to receive information indicative that the transmission mode for inactive state reception is used for the multicast session in at least one or more neighbouring cells, and prepare for receiving data for the multicast session based on the transmission mode for inactive state reception when selecting a cell of the one or more neighbouring cells or when being handed over to a cell of the one or more neighbouring cells.

The apparatus may be configured to transition between a connected state reception and the inactive state reception.

The apparatus may be configured to receive a release message triggering transitioning from the connected state reception to the inactive state reception and identifying the multicast session for the inactive state reception and/or send a request for transitioning from the inactive state reception to the connected state reception in response to participating in a multicast session in the inactive state and at least one of receiving information indicative of use of the transmission mode for connected state reception for the multicast session or not receiving information indicative of use of the transmission mode for inactive state reception for the multicast session. The area may comprise a cell.

In accordance with a further aspect there is provided a method in a network node comprising: deciding, for a cell, whether to apply a transmission mode for reception in RRC-inactive state or a transmission mode for reception in RRC_connected state for a multicast session; transmitting data of the multicast session in the cell using either the transmission mode for reception in the RRC-inactive state or the transmission mode for reception in the RRC_connected state for the multicast session based on the decision; and providing information to user equipment in the cell indicative that the transmission mode for the reception in RRC_inactive state is used for the multicast session.

The method can further comprise receiving an indication whether a served user equipment is capable of receiving multicast data while in the RRC_inactive state.

The method can further comprise receiving an indication that a served user equipment joined the multicast session.

The decision whether to apply the transmission mode for reception in the RRC_inactive state or the transmission mode for the reception in the RRC_connected state for the multicast session in a cell can at least partially be based on at least on one or more of the following criteria: number of user equipment wanting to receive the multicast session in the cell; RRC state of user equipment in the multicast session in the cell or one or more RAN notification areas including the cell; load in the cell; capabilities of user equipment that have joined the multicast session in the cell to receive multicast data while in RRC_inactive state; preferences of user equipment that have joined the multicast session in the cell to use transmission mode for reception in RRC inactive state or the transmission mode for the reception in RRC_connected state; and preferences received from the core network to use the transmission mode for reception in RRC-inactive state or the transmission mode for reception in RRC_connected state for the multicast session.

The method as above, wherein a user equipment in RRC_connected state or RRC_inactive state is capable of receiving the transmission mode for reception in RRC-inactive state.

The information that the transmission mode for reception in the RRC_inactive state is used for the multicast session may further comprise an indication whether the multicast session is active or inactive. The information that the transmission mode for reception in RRC_inactive state is used for the multicast session can also be only provided if the multicast session is active.

The information that the transmission mode for reception in RRC_inactive state is used for the multicast session may comprise an identifier of the multicast session.

The method may further comprise transmitting an indication whether the transmission mode for reception in RRC_inactive state is used for the multicast session in one or more neighbouring cells.

Said providing information to user equipment in the cell that the transmission mode for reception in RRC_inactive state is used for the multicast session may comprise configuring the user equipment for monitoring of one or more MCCH/MTCH and transmitting the multicast session identifier with MTCH configuration for the multicast session in MCCH. Alternatively, said providing of information to user equipment in the cell that the transmission mode for reception in RRC_inactive state is used for the multicast session may comprise providing an indication that the transmission mode for reception in RRC_inactive state is used for the multicast session together with a configuration for monitoring MCCH/MTCH in PDCCH-ConfigCommon and transmitting the multicast session identifier in MCCH.

The method may further comprise transmitting an indication to user equipment in the cell to use the transmission mode for reception in RRC_connected state. The transmitting of the indication to the user equipment in the cell to use the transmission mode for reception in RRC_connected state may comprise configuring the user equipment using dedicated RRC signalling for the reception of the multicast session.

In accordance with a yet further aspect there is provided a method for a receiver device, for example a user equipment, comprising: receiving information that the transmission mode for reception in RRC-inactive state is used for a multicast session in the cell; and receiving data of the multicast session in the cell based on the transmission mode for reception in RRC_inactive state based on the information that the transmission mode for reception in RRC inactive state is used for the multicast session.

The method may further comprise transmitting an indication of the capability of the user equipment of receiving multicast data while in RRC_inactive state.

The method may further comprise sending a request to join the multicast session, and receive a response informing the user equipment about the success of the join request and a multicast session identity.

The method may further comprise receiving data of the multicast session in the cell using the transmission mode for reception in RRC_inactive state while being in RRC_connected state or RRC_inactive state.

The information that the transmission mode for reception in RRC_inactive state is used for the multicast session may further comprise an indication whether the multicast session is active or inactive.

The information that the transmission mode for reception in RRC_inactive state is used for the multicast session may only be provided if the multicast session is active.

The information that the transmission mode for reception in RRC_inactive state is used for the multicast session may comprise an identifier of the multicast session.

The method may further comprise receiving an indication whether the transmission mode for reception in RRC_inactive state is used for the multicast session in one or more neighbouring cells, and preparing to receive data for the multicast session using that transmission mode when selecting that cell or being handed over to that cell.

The receiving of information that the transmission mode for reception in RRC_inactive state is used for the multicast session may comprise receiving a configuration for monitoring one or more MCCH/MTCH, receiving the multicast session identifier and receiving MTCH configuration for the multicast session in the MCCH.

The receiving of information that the transmission mode for reception in RRC_inactive state is used for the multicast session comprises receiving that the indication that the transmission mode for reception in RRC_inactive state is used for the multicast session together with configuration for monitoring one or more MCCH/MTCH in PDCCH-ConfigCommon and receiving the multicast session identifier in the MCCH.

The method may further comprise receiving an indication to use the transmission mode for reception in RRC_connected state.

Receiving of the indication at a user equipment in the cell to use the transmission mode for reception in RRC_connected state may comprise receiving configuration in dedicated RRC signalling for the reception of the multicast session.

The method may further comprise sending a service request when receiving an indication to use the transmission mode for reception in RRC_connected state and being in RRC_idle state.

The method may further comprise sending a service request when not receiving an indication to use the transmission mode for reception in RRC_inactive state for a configured period in a cell, being located within the service area of the multicast session, and being in RRC_idle or RRC_inactive state.

Means for implementing the herein disclosed operations and functions can also be provided. The means can comprise appropriately configured hardware and/or software.

A computer software product embodying at least a part of the herein described functions may also be provided. In accordance with an aspect a computer program comprises instructions for performing at least one of the methods described herein.

### BRIEF DESCRIPTION OF DRAWINGS

Some aspects will now be described in further detail, by way of example only, with reference to the following examples and accompanying drawings, in which:

FIG. 1 illustrates an example of a system where the invention can be practiced;

FIG. 2 shows an example of a control apparatus;

FIGS. 3, 4, 5 and 6 show flowcharts illustrating examples of operation in a device and in an access node; and

FIGS. 7 to 10 are signaling flowcharts according to certain examples.

### DETAILED DESCRIPTION OF EXAMPLES

The following description gives an exemplifying description of some possibilities to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

Wireless communication systems provide wireless communications to devices connected therein. Typically, an access point such as a base station or other node of a radio access system (RAN) is provided for enabling the communications. In the following, different scenarios will be described using, as an example of an access architecture, a 3GPP 5G radio architecture. However, embodiments are not necessarily limited to such an architecture. Some examples of options for suitable systems are the universal mobile telecommunications system (UMTS) radio access network (UTRAN or E-UTRAN), long term evolution (LTE), LTE-A (LTE advanced), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS) or any combination and further development thereof.

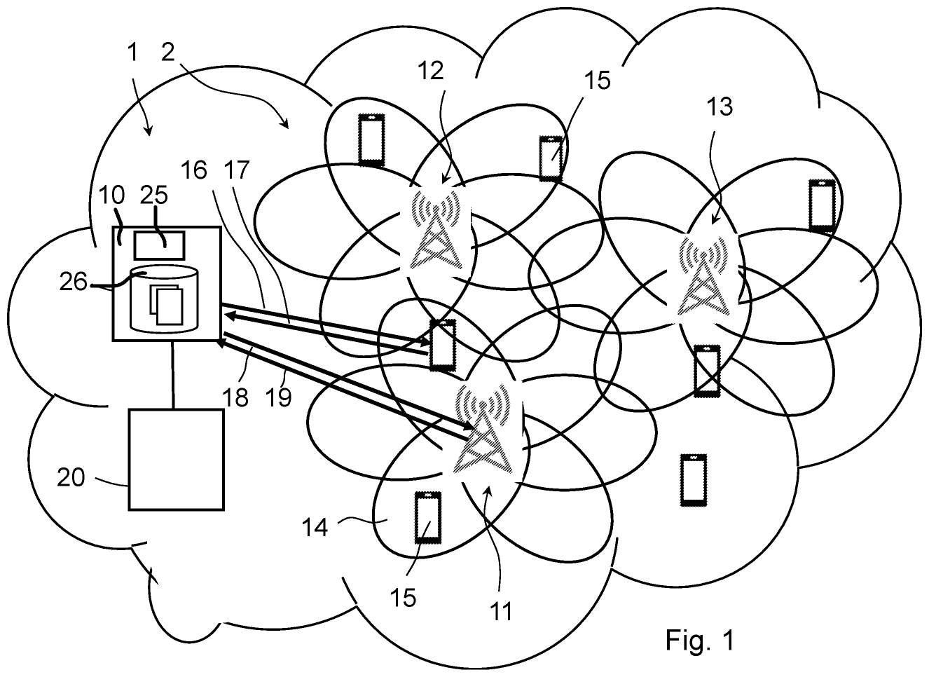

FIG. 1 shows a schematic example of a communication system 1 comprising a radio access network (RAN) 2. A radio access network can comprise one or a plurality of radio access network nodes (RAN nodes), 11, 12 and 13. A RAN node may provide one or more cells 14. A RAN node can comprise any node that can transmit/receive radio signals (e.g., a TRP, a 3GPP 5G base station such as gNB, eNB, a user device and so forth). A large number of radio access networks can be provided in a communication system. For simplicity, only a few communication devices, RAN nodes, cells and a radio access network are shown. A radio access network can comprise a number of RAN nodes (e.g., base stations). Communication devices 15 can be located in the service area of the radio access network 2. Devices 15 in cells 14 can communicate with the RAN nodes 11-13.

FIG. 1 shows an apparatus that includes a session management function 20. The session management function can comprise, e.g., a Multicast/Broadcast Session Management Function (MB-SMF). An apparatus 10 including a control function is provided between the apparatus including the session management function 20 and the RAN nodes 11, 12 and 13. The control function may be an Access and Mobility Management Function (AMF). The AMF provides an intermediate control function, the general principle being that a Multicast/Broadcast Session (MBS) is built by the Multicast/Broadcast Session Management Function (MB-SMF) and remains transparent to the Access and Mobility Management Function (AMF). The AMF manages broadcast areas and Registration Area (RA) nodes (base stations such as e.g., gNBs in the 5G). The apparatus 10 that includes the AMF includes at least one processor 25 and memory 26. The AMF can send and receive messages 16 and 17 with the user equipment and messages 18, 19 with the RAN nodes. The configuration, operation and relevant functionalities of the AMF will be described later in more detail.

It is noted that the communication system 1 is only shown as a cloud and can comprise a number of other elements which are not shown for clarity. For example, various operations and functions in accordance with a 5G based system may be comprised in a terminal or user equipment (UE), a 5G radio access network (5GRAN) or next generation radio access network (NG-RAN), a 5G core network (5GC), one or more application functions (AF) and one or more data networks (DN). The 5G-RAN may comprise one or more gNodeBs (gNBs)) or one or more gNodeB distributed unit functions connected to one or more gNodeB centralized unit functions. The 5GC may also comprise entities such as Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); various Session Management Functions (SMF) and so on.

The communication devices 15 may be any suitable devices adapted for wireless communications. Non-limiting examples comprise a mobile station (MS) (e.g., a mobile device such as a mobile phone or what is known as a ‘smart phone’), a computer provided with a wireless interface card or other wireless interface facility (e.g., USB dongle), personal data assistant (PDA) or a tablet provided with wireless communication capabilities, machine-type communications (MTC) devices, Internet of Things (IoT) type communications devices, a Cellular Internet of things (CIoT) device or any combinations of these or the like. The device may be provided as part of another device. The device may receive signals over an air or radio interface via appropriate apparatus for receiving and may transmit signals via appropriate apparatus for transmitting radio signals. The communications can occur via multiple paths. To enable MIMO type communications devices may be provided with multiantenna elements.

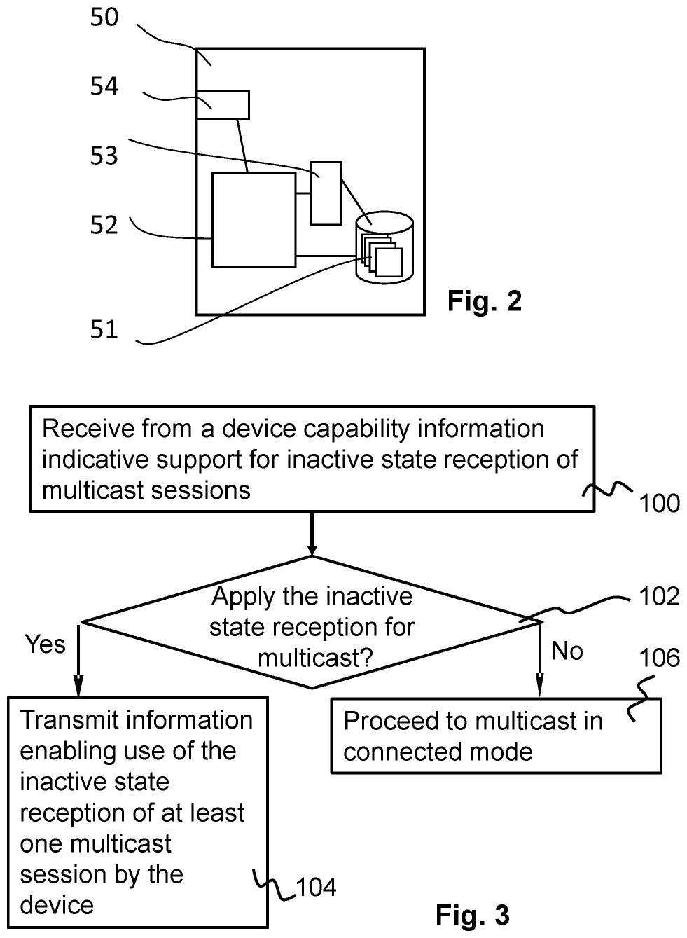

Communication devices such as access nodes, terminal devices and network functions are provided with data processing apparatus comprising at least one processor and at least one memory. FIG. 2 shows an example of a data processing apparatus 50 comprising processor(s) 52, 53 and memory or memories 51. FIG. 2 further shows connections between the elements of the apparatus and an interface for connecting the data processing apparatus to other components of the device. The at least one memory may comprise at least one ROM and/or at least one RAM. The communications device may comprise other possible components for use in software and hardware aided execution of tasks it is designed to perform, including implementing the herein described features in relation to multicast and/or broadcast services. The at least one processor can be coupled to the at least one memory. The at least one processor may be configured to execute an appropriate software code to implement one or more of the following aspects. The software code may be stored in the at least one memory, for example in the at least one ROM.

The following describes certain aspects, configurations and signaling related operations using 3GPP terminology. More particularly, certain detailed examples of providing, inter alia, backward compatibility for inactive or idle reception of a multicast service are discussed. Compatibility issues may arise because, e.g., 3GPP Rel-17 defines procedures for multicast that are restricted to UEs in radio resource control (RRC) connected state whereas later releases do not have this limitation.

Radio resource control (RRC) is used for controlling wireless communications. Conventionally RRC provided two states, RRC_CONNECTED and RRC_IDLE. A further RRC state for inactive UEs, referred to as RRC_INACTIVE, was introduced in 3GPP New Radio (NR) Rel-15 to complement the RRC_CONNECTED and RRC_IDLE states to provide a state for lean signalling and energy-efficient support of NR services between the RRC_CONNECTED and RRC_IDLE states. The RRC_INACTIVE state enables quicker resume of an earlier suspended connection and start of transmission of small or sporadic data with low initial access delay and associated signalling overhead compared to the RRC_IDLE state. This is mainly facilitated by reduced control signalling required for requesting and obtaining the resume of a suspended RRC connection. The transition from RRC_CONNECTED to RRC_INACTIVE, can be triggered by the RAN node (e.g., gNB) using a RRCRelease message that includes suspend configuration information. When a UE is moved to RRC_INACTIVE, the UE Access Stratum (AS) context (referred to as UE Inactive AS Context), necessary for the quick resume of the suspended connection, is maintained both at the UE side and RAN side, and it is identified at the network side by a UE identifier, e.g., Inactive-Radio Network Temporary Identifier (I-RNTI).

Multicast Broadcast Service (MBS) is an example of a point-to-multipoint communication service where data can be transmitted simultaneously from a single source to multiple destinations/devices. Broadcast refers to the ability to deliver content to all users in an area. The broadcast content may be transmitted over a broadcast area. A broadcast area is a collection of one or more network access nodes, e.g., base stations, and/or cells that are capable of delivering the same content. Multicast in turn refers to transmission to a set of targeted devices. The number and variety of mobile multicast applications are growing and increase in multicast traffic load is expected. In addition to mobile user devices, multicast services can target a wide variety of devices such as machine-type communications (MTC) for the Internet of Things (IoT). Mixed broadcast-multicasts may also be provided.

According to 3GPP Rel-17 multicast is restricted to UEs in radio resource control (RRC) connected mode. 3GPP Rel-17 compliant RAN nodes behave accordingly and a UE served by such RAN nodes shall be in RRC connected mode to receive multicast data for the RAN node. Similarly, a Rel-17 compliant UE is only required to be capable of receiving in the RRC connected mode. RAN nodes serving the UE shall operate accordingly so that the UE receives the multicast data. On the other hand, 3GPP Rel-18 compliant RAN nodes and UEs can support multicast transmissions towards inactive UEs. In such case RAN nodes may decide whether to apply the inactive UE mode for a multicast session or cell. The decision may be based on various factors, e.g., on the number of UEs in a cell, amount of data to be transmitted and so on.

The following explain a mechanism how to handle a situation where a UE may need to be notified whether the transmission mode used by the RAN node is for inactive reception or if the RAN node uses a transmission mode for connected mode reception for the cell. For example, a RAN node may advertise inactive/idle support or inactive/idle usage for a multicast broadcast service (MBS) session.

FIG. 3 shows a flow chart for operation at a RAN node for configuring a device for least one multicast session according to an example. The RAN node receives at 100 from a receiver device capability information indicative that the receiver device supports inactive state reception for multicast sessions. A decision is made at 102 by the RAN node to apply transmission mode for inactive state reception for transmission to the receiver device for at least one multicast session. The RAN node can then transmit at 104 information for enabling use of the inactive mode for the at least one multicast session by the receiver device.

If the RAN node decides at 102 that inactive reception of multicast data is not appropriate for the multicast transmission to the receiver device, it may proceed with multicasting in connected mode.

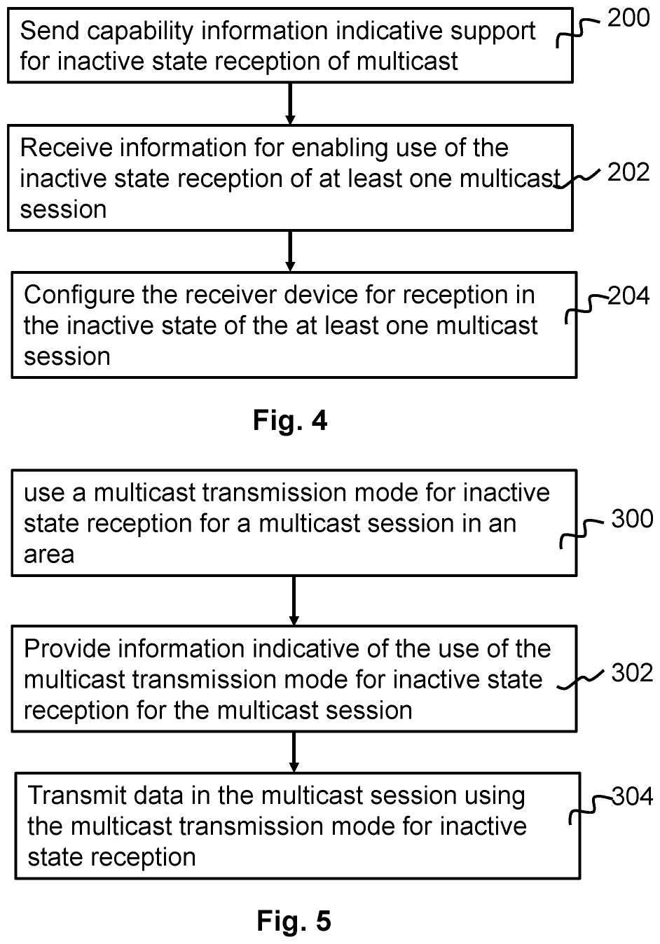

FIG. 4 shows a flow chart for operation at a receiver device for receiving at least one multicast session according to an example. The receiver device sends at 200 capability information to a RAN node indicative that the receiver device supports inactive state reception of multicast sessions. The receiver device may then receive at 202 in response information from the RAN node for enabling use of the inactive state multicast reception for at least one multicast session. The receiver device is configured accordingly at 204 for the inactive state reception in the inactive multicast mode of the at least one multicast session.

It shall be appreciated that the term inactive state reception of multicast sessions is intended to cover reception in radio recourse control (RRC) inactive state (e.g., RRC_INACTIVE state) or RRC idle state (e.g., RRC_IDLE state).

FIG. 5 shows another example for operation at an access node. In step 300 a decision is made to use a multicast transmission mode for inactive state reception for a multicast session in an area. Information is provided at 302 for at least one device in the area indicative of the use of the multicast transmission mode for inactive state reception for the at least one multicast session. Data is then transmitted at 304 in the at least one multicast session using the multicast transmission mode for inactive state reception.

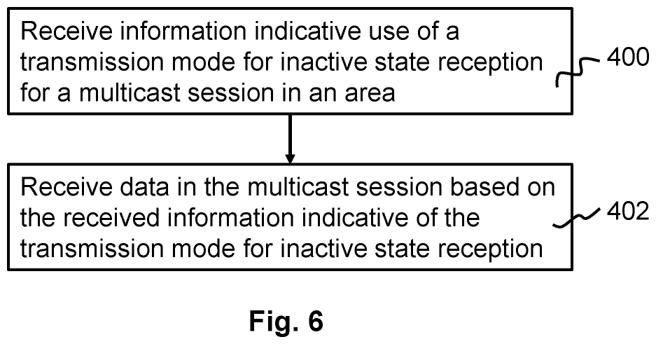

FIG. 6 shows a further example for operation at a device receiving multicast data. In the method information indicative use of a transmission mode for inactive state reception for a multicast session in an area is received at 400. Data in the multicast session is then received at 402 based on the information indicative of the transmission mode for inactive state reception.

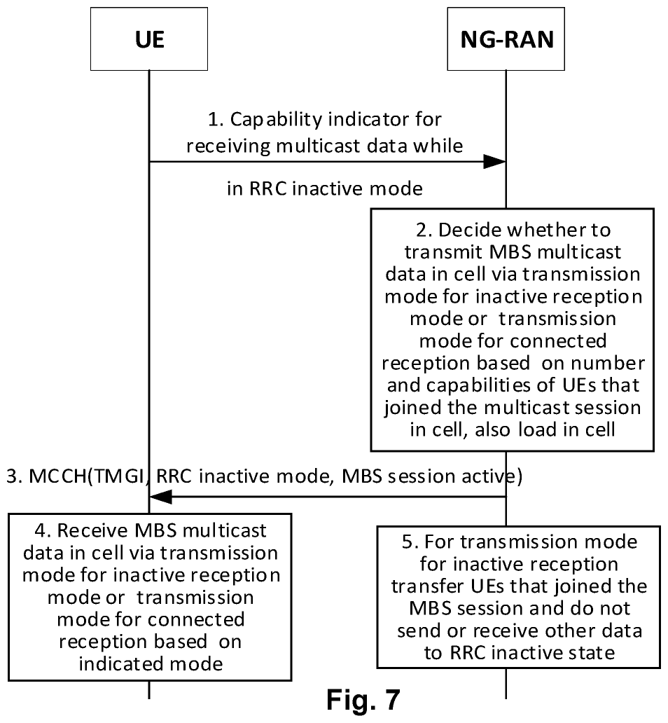

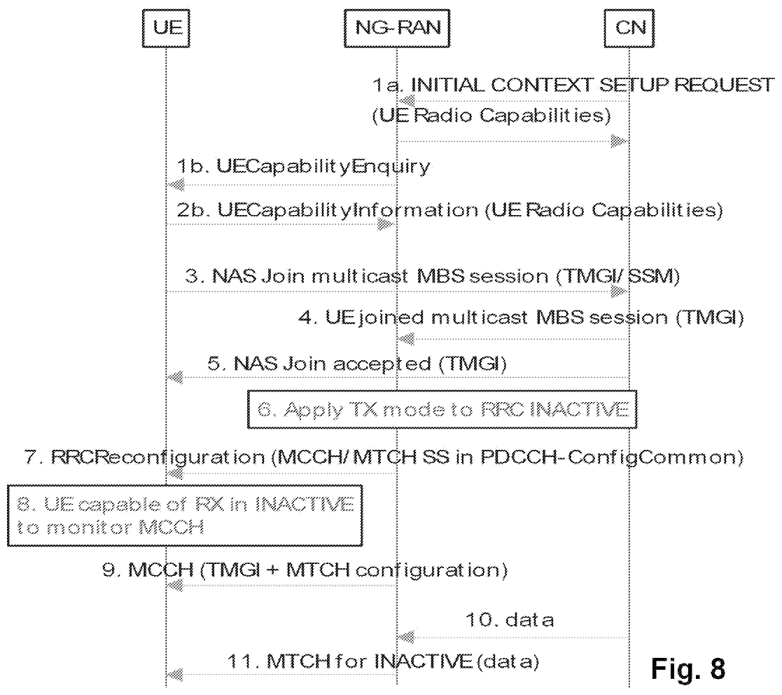

FIG. 7 shows a signalling flow chart according to a more detailed example of operation using 5G terminology. A UE transmits at message 1 its capability to support multicast reception in RRC inactive state (e.g., RRC_INACTIVE state). The transmission may occur via AMF to relevant RAN node or nodes, see messages 17 and 18 in FIG. 1. The capability information may also be forwarded to other RAN nodes when a UE is handed over. The RAN node can decide at stage 2 based on, e.g., the number of UEs in a cell, the load in the cell or other defined area, and/or the capabilities of the relevant UEs whether to apply a transmission mode for connected mode reception or a transmission mode for inactive mode reception for a multicast session (e.g., an MBS session) in the cell. Other non-limiting examples of information that may form basis for the decision making include the number of devices in an area desiring to receive the multicast session, radio resource control state of devices in the multicast session in the area or one or more notification areas including the area, capabilities of devices that have joined the multicast session in the area to receive multicast data while in radio resource control inactive state, preferences of devices that have joined the multicast session in the area to use the transmission mode for reception in radio resource control inactive state or a transmission mode for reception in radio resource control connected state, and preferences received from the core network to use the transmission mode for reception in radio resource control inactive state or a transmission mode for reception in radio resource control connected stat

Inactive/idle MBS multicast transmission can then broadcast an indication that the transmission mode for RRC inactive state reception is applicable in a cell for the multicast session over a radio channel within that cell at stage 3. The indication can comprise an ID of the multicast session.

The UE may then receive at step 4 multicast data via transmission mode for inactive/idle mode reception or connected mode reception according to the indicated mode. The RAN node can transfer at stage 5 UEs that joined the multicast session and do not send or receive other data to the inactive state and for reception of the multicast data accordingly.

In accordance with a possibility broadcast message 3 only applies for multicast sessions which are active in the cell(s) or the session ID is only broadcasted while the corresponding MBS session is active. In accordance with another possibility broadcast message 3 comprises an indication whether the multicast session is active or inactive.

In accordance with a possibility the session ID is also broadcasted in cells where the transmission mode for connected mode reception applies to together with an indication that the transmission mode for connected mode reception applies.

The information relating to the use of inactive/idle-mode reception may be transmitted in a point-to-multipoint control channel over the radio link.

The transmission of the indication that the transmission mode for RRC inactive mode reception is applicable in a cell or a group of cells may happen also for neighboring cells to enable a more seamless reception when a UE reselects another cell. For that purpose RAN nodes may send to neighbor nodes part or all of the information described above. The neighbouring nodes may transmit the information with an indication to which cells it applies.

When an UE in idle or inactive state desiring to receive data of a multicast session starts to be served by a RAN node it can detect that the RAN node does not advertise the usage of the transmission mode for inactive state reception for the multicast or that the RAN advertises the usage of the transmission mode for connected mode reception for the multicast session. In such an occasion the UE can send a service request to transition to the RRC connected state.

When a UE desiring to receive a multicast session is already in the RRC connected mode it can determine whether the transmission mode for inactive/idle state reception or the transmission mode for connected state reception shall be applied for a multicast session based on the information broadcasted in the cell or another defined broadcast area.

FIG. 8 shows an example where a gNB receives UE's capability of multicast reception in RRC inactive state in UE's radio capability information. The information may be received from the AMF during UE context setup or directly from the UE. In the example the capability information is received in message 2b in response to capability enquiry 1b by the RAN node. This in turn may have been triggered by initial connection set-up request message 1a the RAN node received from the core network (CN). Conventional session set up messages such as 3, 4 and 5 may then follow to exchange information of features such as Temporary Mobile Group Identity (TMGI) and Source Specific Multicast (SSM).

The RAN node can decide in step 6 to apply the transmission mode for inactive state UEs. The decision may be based, e.g., on the number of UEs in a cell, based on the load in the cell, and/or based on the capabilities of the UEs. Configuration of the transmission mode for RRC inactive is then provided. In step 7 the UE is configured with search space (SS) for Multicast Control Channel/Multicast Traffic Channel (MCCH/MTCH) as part of Physical Downlink Control channel (PDCCH) ConfigCommon configuration in RRC reconfiguration message. In step 8, upon reception of the MCCH/MTCH SS, UE capable of multicast reception in RRC inactive state monitors MCCH for a TMGI associated with the multicast session.

If the RAN node decided to apply transmission mode for RRC inactive state then it can just transmit MCCH with needed MTCH configuration for the session at step 9. If the RAN node decided to apply transmission mode for RRC connected state then it can configure the UE using UE dedicated RRC signaling where the RAN configures a MBS radio bearer.

In stage 10 data for transmission is received from the CN. The data is then multicast at stage 11 on the MTCH according to the inactive mode reception.

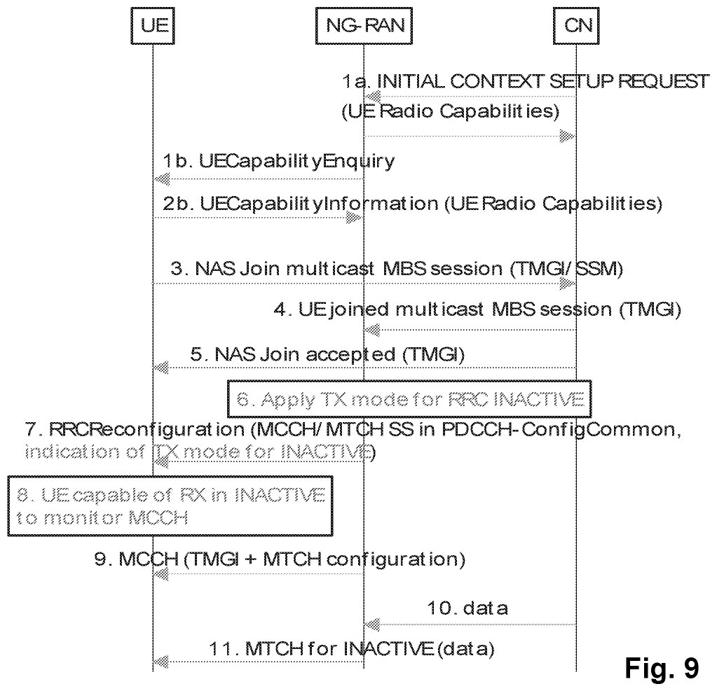

FIG. 9 shows another example where a NG-RAN (e.g. a gNB of the NG-RAN) receives UE's capability of multicast reception in RRC inactive state in UE's radio capabilities either from the AMF of the CN during UE context setup or from the UE. Following steps 1-5 as above, the RAN node can decide at step 6 to apply the transmission mode for inactive UEs. The decision may be based, e.g., on the number of UEs in a cell, based on the load in the cell, and/or based on the capabilities of the UEs and so on. Configuration of the transmission mode for RRC inactive state follows and in step 7 the NG-RAN provides explicit indication to the UE that it will apply transmission mode for RRC inactive state. This can be provided in the same message where SS for MCCH/MTCS as part of PDCCH-ConfigCommon configuration is provided. In step 8, upon the reception of the SS configuration for MCCH/MTCH reception and the indication, the UE capable of multicast reception in RRC inactive state monitors MCCH for TMGI associated with the multicast session. Steps 9 to 11 can then follow as above.

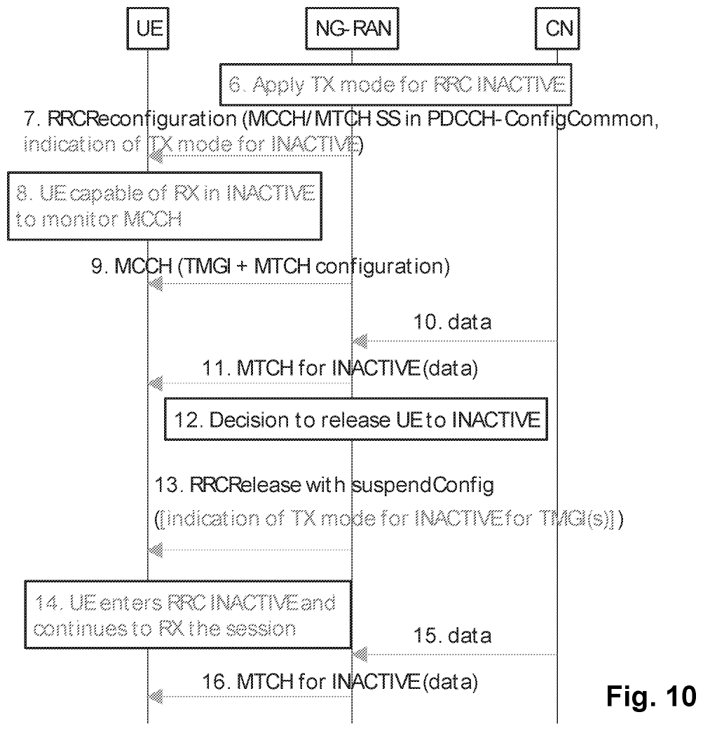

Transition between RRC connected and RRC inactive states is explained next with reference to the signalling flowchart of FIG. 10. The example is shown to start from step 6 and continue until step 11 as in FIG. 9. In the following steps the UE is moved from connected state to inactive state.

The RAN can decide at step 12 to release the UE to have the UE transition to the RRC inactive state. The RAN node can then send RRCRelease message 11 with suspendConfig information element in message 13. The message can include indication of inactive transmission mode.

The NG-RAN may at this stage also directly release the UE to RRC inactive and step 7 may be skipped. In that case, the RRCRelease message may also include an indication what session(s) are/will be provided using the transmission mode for inactive state. The session(s) can be indicated by the TMGI(s).

A UE may also be moved from inactive state to connected state. In this case the RAN node can remove the TMGI(s) and corresponding MTCH configuration from MCCH which can implicitly trigger the UE to request RRC connection resumption. The NG-RAN may also remove the TMGI(s) and the corresponding MTCH if there are no data for the multicast session or if a RAN node of the NG-RAN receives the deactivation of the multicast session from the core network. Therefore, the UE can request the resumption of RRC connection when it receives paging (group paging or individual CN/RAN paging).

It is also possible that MCCH can include an indication per TMGI whether the session is being provided by the transmission mode for RRC connected state or the transmission mode for RRC inactive state. If the UE receives and indication that the session is being provided by the transmission mode for RRC connected then the UE can request resumption of the RRC connection.

Such operation may also be needed if a RAN node wants to provide a session to Rel-17 UEs using the transmission (TX) mode for reception in connected state while there are at the same time Rel-18 capable UEs that could use the TX mode for reception in inactive state. In this case, Rel-18 UEs can respond to the group paging and request for resumption of RRC connection if the MCCH indicates that the TX mode is for reception in connected state. Otherwise, the UE shall refrain from requesting the resumption of RRC connection.

In accordance with an example the apparatus of FIGS. 1 and 2 can be configured to implement a method comprising deciding, for a cell, whether to apply a transmission mode for reception in RRC inactive state or a transmission mode for reception in RRC connected state for a multicast session, transmitting data of the multicast session in the cell using either the transmission mode for reception in the RRC inactive state or the transmission mode for reception in the RRC connected state for the multicast session based on the decision, and providing information to user equipment in the cell indicative that the transmission mode for the reception in RRC inactive state is used for the multicast session.

The method can further comprise receiving an indication whether a served user equipment is capable of receiving multicast data while in the RRC inactive state.

The method can further comprise receiving an indication that a served user equipment joined the multicast session.

The decision whether to apply the transmission mode for reception in the RRC inactive state or the transmission mode for the reception in the RRC connected state for the multicast session in a cell can at least partially be based on at least on one or more of the following criteria: number of user equipment wanting to receive the multicast session in the cell; RRC state of user equipment in the multicast session in the cell or one or more RAN notification areas including the cell; load in the cell; capabilities of user equipment that have joined the multicast session in the cell to receive multicast data while in RRC inactive state; preferences of user equipment that have joined the multicast session in the cell to use transmission mode for reception in RRC inactive state or the transmission mode for the reception in RRC connected state; and preferences received from the core network to use the transmission mode for reception in RRC inactive state or the transmission mode for reception in RRC connected state for the multicast session.

The method as above, wherein a user equipment in RRC connected state or RRC inactive state is capable of receiving the transmission mode for reception in RRC-inactive state.

The information that the transmission mode for reception in the RRC inactive state is used for the multicast session may further comprise an indication whether the multicast session is active or inactive. The information that the transmission mode for reception in RRC inactive state is used for the multicast session can also be only provided if the multicast session is active.

The information that the transmission mode for reception in RRC inactive state is used for the multicast session may comprise an identifier of the multicast session.

The method may further comprise transmitting an indication whether the transmission mode for reception in RRC inactive state is used for the multicast session in one or more neighbouring cells.

Said providing information to user equipment in the cell that the transmission mode for reception in RRC inactive state is used for the multicast session may comprise configuring the user equipment for monitoring of one or more MCCH/MTCH and transmitting the multicast session identifier MTCH configuration for the multicast session in MCCH. Alternatively, said providing of information to user equipment in the cell that the transmission mode for reception in RRC inactive state is used for the multicast session may comprise providing an indication that the transmission mode for reception in RRC inactive state is used for the multicast session together with a configuration for monitoring MCCH/MTCS in PDCCH-ConfigCommon and transmitting the multicast session identifier in MCCH.

The method may further comprise transmitting an indication to user equipment in the cell to use the transmission mode for reception in RRC connected state. The transmitting of the indication to the user equipment in the cell to use the transmission mode for reception in RRC connected state may comprise configuring the user equipment using dedicated RRC signalling for the reception of the multicast session.

In accordance with yet another example the apparatus of FIGS. 1 and 2 can be configured to implement a method in a receiver device, for example a user equipment, comprising receiving information that the transmission mode for reception in RRC inactive state is used for a multicast session in the cell, and receiving data of the multicast session in the cell based on the transmission mode for reception in RRC inactive state based on the information that the transmission mode for reception in RRC inactive state is used for the multicast session.

The method in the receiver device may further comprise transmitting an indication of the capability of the user equipment of receiving multicast data while in RRC inactive state.

The method in the receiver device may further comprise sending a request to join the multicast session and receive a response informing the user equipment about the success of the join request and a multicast session identity.

The method may further comprise receiving data of the multicast session in the cell using the transmission mode for reception in RRC inactive state while being in RRC connected state or RRC inactive state.

The information that the transmission mode for reception in RRC inactive state is used for the multicast session may further comprise an indication whether the multicast session is active or inactive.

The information that the transmission mode for reception in RRC inactive state is used for the multicast session may only be provided if the multicast session is active.

The information that the transmission mode for reception in RRC inactive state is used for the multicast session may comprise an identifier of the multicast session.

The method may further comprise receiving an indication whether the transmission mode for reception in RRC inactive state is used for the multicast session in one or more neighbouring cells and preparing to receive data for the multicast session using that transmission mode when selecting that cell or being handed over to that cell.

The receiving of information that the transmission mode for reception in RRC inactive state is used for the multicast session may comprise receiving a configuration for monitoring one or more MCCH/MTCH, receiving the multicast session identifier and receiving MTCH configuration for the multicast session in the MCCH.

The receiving of information that the transmission mode for reception in RRC inactive state is used for the multicast session comprises receiving that the indication that the transmission mode for reception in RRC inactive state is used for the multicast session together with a configuration for monitoring one or more MCCH/MTCH in PDCCH-ConfigCommon and receiving the multicast session identifier in the MCCH.

The method may further comprise receiving an indication to use the transmission mode for reception in RRC connected state.

Receiving of the indication at a user equipment in the cell to use the transmission mode for reception in RRC connected state may comprise receiving configuration in dedicated RRC signalling for the reception of the multicast session.

The method may further comprise sending a service request when receiving an indication to use the transmission mode for reception in RRC connected state and being in RRC idle state.

The method may further comprise sending a service request when not receiving an indication to use the transmission mode for reception in RRC inactive state for a configured period in a cell, being located within the service area of the multicast session and being in RRC inactive or RRC idle state.

It is noted that while the above describes example embodiments, there are several variations and modifications which may be made to the disclosed solution without departing from the scope of the present invention. Different features from different embodiments may be combined.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. Alternatively or additionally some embodiments may be implemented using circuitry. The circuitry may be configured to perform one or more of the functions and/or method procedures previously described. That circuitry may be provided in the network entity and/or in the communications device and/or a server and/or a device.

As used in this application, the term “circuitry” may refer to one or more or all of the following:
(a) hardware-only circuit implementations (such as implementations in only analogue and/or digital circuitry);
(b) combinations of hardware circuits and software, such as: (i) a combination of analogue and/or digital hardware circuit(s) with software/firmware and (ii) any portions of hardware processor(s) with software (including digital signal processor(s)), software, and memory(ies) that work together to cause the communications device and/or device and/or server and/or network entity to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

It is noted that whilst embodiments have been described in relation to certain architectures, similar principles can be applied to other systems. Therefore, although certain embodiments were described above by way of example with reference to certain exemplifying architectures for wireless networks, technologies standards, and protocols, the herein described features may be applied to any other suitable forms of systems, architectures and devices than those illustrated and described in detail in the above examples. It is also noted that different combinations of different embodiments are possible. It is also noted herein that while the above describes exemplifying embodiments, there are several variations and modifications which may be made to the disclosed solution without departing from the spirit and scope of the present invention.

1-24. (canceled)

25. An apparatus for a radio access network node, the apparatus comprising:
at least one processor; and
at least one memory storing instructions which, when executed by the at least one processor, cause the apparatus to perform operations, the operations comprising at least:
deciding that a device is to use a radio resource control (RRC) inactive state for reception of data of a multicast session in an area,
providing, to the device, information indicating that the device is to use the RRC inactive state for reception of the data of the multicast session, and
transmitting the data of the multicast session to the device that is using the RRC inactive state for reception of the data of the multicast session.

26. The apparatus according to claim 25, wherein the operations further comprise receiving capability information indicative that the device supports reception of data for multicast sessions in the RRC inactive state.

27. (canceled)

28. The apparatus according to any of claim 25, wherein deciding comprises deciding that the device is to use the RRC inactive state for reception of the data of the multicast session based on at least one of:
capabilities of devices in the area;
capabilities of devices in an area that have joined the multicast session to receive the data while the devices are in the radio resource control inactive state; or
preferences received from a core network indicating that the device is to use the the RRC radio resource control inactive state or a radio resource control connected state for reception of the data of the multicast session.

29. The apparatus according to claim 25, wherein the providing the information comprises broadcasting the information.

30. The apparatus according to claim 25, wherein the operations further comprise transmitting information indicative that the multicast session is provided in a cell and in one or more neighbouring cells of the cell.

31-43. (canceled)

44. The apparatus according to claim 25, wherein the operations further comprise:
prior to the transmitting the data, transmitting, to the device, a RRC release message to cause the device to transition to the RRC inactive state.

45. The apparatus according to claim 25, wherein the providing comprises:
transmitting, to the device, a RRC release message to cause the device to transition to the RRC inactive state, wherein the RRC release message comprises the information and an identifier of the multicast session.

46. The apparatus according to claim 25, wherein the providing comprises:
transmitting, in a multicast control channel (MCCH), a multicast traffic channel (MTCH) configuration for the multicast session, the MTCH configuration comprising the information and an identifier of the multicast session.

47. A device comprising:
at least one processor; and
at least one memory storing instructions which, when executed by the at least one processor, cause the device to perform operations, the operations comprising:
receiving, from a radio access network node, information indicating that the device is to use a radio resource control (RRC) inactive state for reception of data of the multicast session;
transitioning to the RRC inactive state; and
receiving, from radio access network node, the data of the multicast session.

48. The device of claim 47, further comprising:
sending, to the radio access network node, an indication that the user equipment supports reception of data of multicast sessions while in the RRC inactive state.

49. The device of claim 47, further comprising:
receiving information indicative that the multicast session is provided in a cell and in one or more neighbouring cells of the cell.

50. The device of claim 47, wherein the receiving comprises receiving a broadcast comprising the information.

51. The device of claim 47, wherein the receiving the information comprises receiving a RRC release message comprising the information; and wherein the transitioning comprises transitioning to the RRC inactive state after receipt of the RRC release message.

52. The device of claim 47, wherein the receiving the information comprises receiving in a multicast control channel (MCCH), a multicast traffic channel (MTCH) configuration for the multicast session, the MTCH configuration comprising the information and an identifier of the multicast session.
